(19) United States
(12) Patent Application Publication
(10) Pub. No.: US 2008/0223092 A1
(43) Pub. Date: Sep. 18, 2008

(54) Electromagnetic Lock Provided with a Sliding Bolt for a Swinging-Type Door

(75) Inventor: Jean-Michel Defert, Sannois (FR)

Correspondence Address: GREENBLUM & BERNSTEIN, P.L.C., 1950 ROLAND CLARKE PLACE, RESTON, VA, 20191, US

(73) Assignee: PROCOFI, Pantin (FR)

(21) Appl. No.: 10/597,508

(22) PCT Filed: Jan. 18, 2005
(86) PCT No.: PCT/FR2005/000054

§ 371 Date: Nov. 3, 2006

(30) Foreign Application Priority Data
Jan. 28, 2004 (FR) 0400773

(51) Int. Cl. E05B 47/02; E05C 19/16

(52) U.S. Cl. 70/144; 292/251.5

(57) ABSTRACT

Electromagnetic lock includes a body, a retractable sliding bolt, and a movable plate structured and arranged to move the retractable sliding bolt and functioning as an armature of an electromagnet housed in the body. The movable plate is movable via two forces acting in the same direction and is structured and arranged to move the retractable sliding bolt to a protruding position. This Abstract is not intended to define the invention disclosed in the specification, nor intended to limit the scope of the invention in any way.

### CROSS-REFERENCE TO RELATED APPLICATIONS

The present application is a National Stage Application of International Application No. PCT/FR2005/000054, filed Jan. 18, 2005, which published as WO 2005/083211 on Sep. 9, 2005. Further, the present application claims priority under 35 U.S.C. § 119 of French Patent Application No. 04/00773 filed on Jan. 28, 2004.

### BACKGROUND OF THE INVENTION

1. Field of the invention

The instant invention relates to an electromagnetic lock provided with a retractable sliding bolt for a swinging-type door, that is, a lock comprising a doubly-tapered bolt. The door is openable by pulling or pushing.

2. Discussion of Background Information

In known locks, the bolt slides in the opening plane by compressing a return spring when an action is exerted against the door.

To oppose the opening of the door, these locks are provided with a locking device preventing the bolt from sliding backward. The device is made of a movable mechanical member that prevents the bolt from sliding back in the locking position.

In general, the movable mechanical locking member is controlled by an electromagnet which, when energized, maintains the aforementioned member in the locking position. If the electromagnet is no longer energized, the aforementioned member retracts by means of a return spring.

Such a lock cannot be used in the case of a door which, while being maintained closed, must be openable, should fortuitous event, such as a fire alarm, occur.

The occurrence of such an event triggers the opening of the electrical circuits, either automatically, or by the security staff.

In general, the alarm trigger causes a panic situation, whereby a large number of people exert an action on the door (an emergency exit, for example), which results in each door being suddenly subjected to a substantial force, and the moving parts (bolt and movable locking member) being blocked one against the other. Experience has shown that a power shut-off has no effect because the force of the return spring is much too insufficient to overcome the force pressing the movable members against one another.

The solution would be to interrupt the power supply as soon as an ill-timed event occurs; but here again, experience has shown that this synchronization is very difficult to achieve.

### SUMMARY OF THE INVENTION

The lock according to the invention, which overcomes these drawbacks, is characterized in that the conventional bolt is supported by the movable armature of an electromagnet. The armature keeps the bolt in the locking position by the action of two forces acting in the same direction. One of the forces results from the spring action, and the other from the action of the electromagnet core when it is energized.

When the electromagnet is energized, the locking is efficient and the bolt is not displaceable.

When the electromagnet is not energized, the bolt is in the exit position, in engagement with the catch, by the action of the springs, and the door is therefore maintained closed in the opening plane. However, pressure on the door makes it possible to slide the bolt backward.

The invention also provides for an electromagnetic lock comprising a body, a retractable sliding bolt, and a movable plate structured and arranged in the body to support the retractable sliding bolt and to function as an armature of an electromagnet. The movable plate is movable via two forces acting in the same direction and is structured and arranged to move the retractable sliding bolt to a protruding position.

At least one of the retractable sliding bolt is configured for a swinging-type door, the retractable sliding bolt comprises a projecting portion having oppositely arranged tapered surfaces, and the retractable sliding bolt comprises a pointed projecting portion.

The movable plate and the retractable sliding bolt are movable in the same direction. The movable plate and the retractable sliding bolt are movable along a bolt displacement direction. The two forces acting in the same direction are generated by springs and the electromagnet. The springs bias the movable plate and the retractable sliding bolt towards the protruding position. The movable plate is guided on columns and the columns comprise axes which are arranged parallel to a bolt displacement direction.

The invention also provides for an electromagnetic lock comprising an electromagnetic core, a retractable sliding bolt, an armature plate supporting the retractable sliding bolt, and springs biasing the armature plate towards the electromagnetic core. When the electromagnetic core is energized, the armature plate positions the retractable sliding bolt in a protruding position and maintains the electromagnetic lock in a locked position. When the electromagnetic core is not energized, forces generated by the springs maintain the protruding position of the retractable sliding bolt.

The retractable sliding bolt is configured for a swinging-type door, and wherein, when the electromagnetic core is not energized, only forces generated by the springs maintain the protruding position of the retractable sliding bolt. The springs are mounted to members passing through the armature plate. The armature plate is guided on columns with axes which are arranged parallel to a bolt displacement direction. At least one of the retractable sliding bolt comprises a projecting portion having oppositely arranged tapered surfaces and the retractable sliding bolt comprises a pointed projecting portion.

The invention also provides for an electromagnetic lock comprising a body, an electromagnetic core arranged in the body, a bolt member comprising a protruding portion and being movable to a protruding position, an armature plate arranged in the body, and springs arranged in the body and biasing the armature plate towards the electromagnetic core. When the electromagnetic core is energized, the electromagnetic lock is maintained in a locked position. When the electromagnetic core is not energized, forces generated by the springs maintain the protruding position until the bolt member experiences a force tending to move the bolt member into the body.

When the electromagnetic core is not energized, only forces generated by the springs maintain the protruding position of the bolt member. The retractable sliding bolt is configured for a swinging-type door and the projecting portion includes oppositely arranged tapered surfaces. The springs are mounted to members passing through the armature plate.

The invention also provides for a method of locking a door, wherein the method comprises arranging the electromagnetic lock described above on an edge of the door, arranging a catch plate on a fixed member, the plate comprising an opening receiving therein the protruding portion of the bolt member, and energizing the electromagnetic core in order maintained the locked position, wherein, when the electromagnetic core is de-energized, biasing forces generated by the springs maintain engagement between the opening and the protruding portion of the retractable sliding bolt.

When the electromagnetic core is de-energized, biasing forces generated only by the springs maintain engagement between the opening and the protruding portion of the retractable sliding bolt, and the springs oppose and allow movement of the bolt member into the body.

The invention also provides for a method of locking a door, wherein the method comprises arranging the electromagnetic lock of described above on an edge of the door, arranging a catch plate on a fixed member, the plate comprising an opening receiving therein a protruding portion of the retractable sliding bolt, and energizing an electromagnetic core in order maintained a locked position, wherein, when the electromagnetic core is de-energized, biasing forces generated only by springs maintain engagement between the opening and the protruding portion of the retractable sliding bolt.

The invention also provides for a method of locking a door, wherein the method comprises arranging the electromagnetic lock of described above on an edge of the door, arranging a catch plate on a fixed member, the plate comprising an opening receiving therein a protruding portion of the retractable sliding bolt, and energizing the electromagnetic core in order maintained the locked position, wherein, when the electromagnetic core is de-energized, biasing forces generated only by the springs maintain engagement between the opening and the protruding portion of the retractable sliding bolt.

### BRIEF DESCRIPTION OF THE DRAWINGS

The invention will be better understood from the description that follows, with reference to the annexed drawings and by way of non-limiting examples, in which:

FIG. 1 is a top view of a lock according to the invention;

FIG. 2 is a cross-sectional view along the line II-II of FIG. 1; and

FIG. 3 is a view, similar to that of 1, showing the position of the movable members during the door opening.

### DETAILED DESCRIPTION OF THE INVENTION

Referring to the drawings, the lock includes, as known, a body 1 fixed, for example, to the edge of the door. A plate 2 is fastened on the fixed portion and forms the catch for retaining the bolt 3.

According to the invention, the bolt 3 is supported by another plate 4, which is displaceable parallel to the edge comprising the plate 2.

The plate 4 is subjected to the action of springs 5 that tend to displace the plate 4 in order to make the bolt 3 protrude.

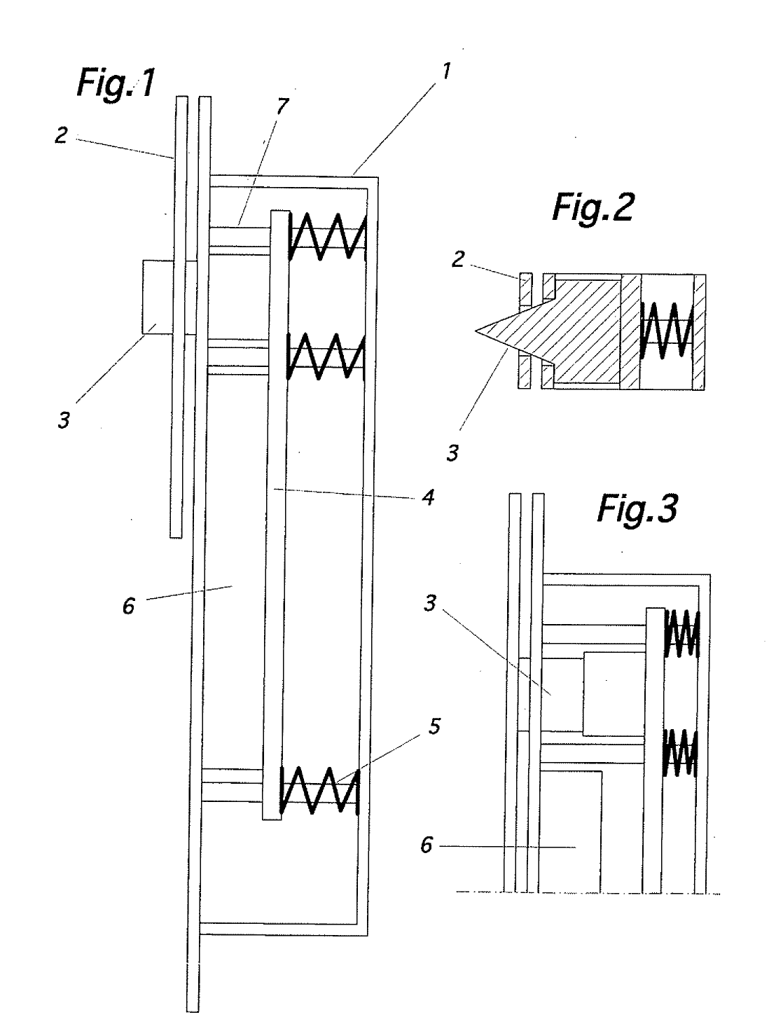

The plate 4 forms the movable armature of an electromagnet. The core 6 of the electromagnet, when energized, displaces the plate 4 in view of making the bolt 3 protrude and then opposes its sliding backward. This is the position shown in FIGS. 1 and 2, which show that the springs 5 press the plate 4 against the core 6.

As seen from the figures, the plate 4 is guided on columns 7. The .axes of these columns 7 are parallel to the bolt 3 displacement direction. The springs 5 are advantageously guided on columns 7.

In its normal operation, the electromagnet is energized and the bolt 3 therefore cannot slide backward: in this state, the lock is locked.

If the power supply to the electromagnet is interrupted, the bolt 3 stays engaged with the catch by action of the springs 5, the door remains closed but not locked, and a mere push on the latter will make it possible to open it.

If a fortuitous event causes a panic situation, people will rush to the doors, exerting a substantial amount of pressure thereon; but this pressure will help with the door opening while the installation's electric power supply is disconnected.

From the above explanations, one can see that the lock according to the invention, contrary to known locks, ensures great safety during a panic reaction.

1-4. (canceled)

5. An electromagnetic lock comprising:
a body;
a retractable sliding bolt; and
a movable plate structured and arranged in the body to support the retractable sliding bolt and to function as an armature of an electromagnet,
wherein the movable plate is movable via two forces acting in the same direction and is structured and arranged to move the retractable sliding bolt to a protruding position.

6. The lock of claim 5, wherein at least one of:
the retractable sliding bolt is configured for a swinging-type door;
the retractable sliding bolt comprises a projecting portion having oppositely arranged tapered surfaces; and
the retractable sliding bolt comprises a pointed projecting portion.

7. The lock of claim 5, wherein the movable plate and the retractable sliding bolt are movable in the same direction.

8. The lock of claim 5, wherein the movable plate and the retractable sliding bolt are movable along a bolt displacement direction.

9. The lock of claim 5, wherein the two forces acting in the same direction are generated by springs and the electromagnet.

10. The lock of claim 9, wherein the springs bias the movable plate and the retractable sliding bolt towards the protruding position.

11. The lock of claim 5, wherein the movable plate is guided on columns and the columns comprise axes which are arranged parallel to a bolt displacement direction.

12. An electromagnetic lock comprising:
an electromagnetic core;
a retractable sliding bolt;
an armature plate supporting the retractable sliding bolt; and
springs biasing the armature plate towards the electromagnetic core,
wherein, when the electromagnetic core is energized, the armature plate positions the retractable sliding bolt in a protruding position and maintains the electromagnetic lock in a locked position, and
wherein, when the electromagnetic core is not energized, forces generated by the springs maintain the protruding position of the retractable sliding bolt.

13. The lock of claim 12, wherein the retractable sliding bolt is configured for a swinging-type door, and wherein, when the electromagnetic core is not energized, only forces generated by the springs maintain the protruding position of the retractable sliding bolt.

14. The lock of claim 12, wherein the springs are mounted to members passing through the armature plate.

15. The lock of claim 12, wherein the armature plate is guided on columns with axes which are arranged parallel to a bolt displacement direction.

16. The lock of claim 12, wherein at least one of:
the retractable sliding bolt comprises a projecting portion having oppositely arranged tapered surfaces; and
the retractable sliding bolt comprises a pointed projecting portion.

17. An electromagnetic lock comprising:
a body;
an electromagnetic core arranged in the body;
a bolt member comprising a protruding portion and being movable to a protruding position;
an armature plate arranged in the body; and
springs arranged in the body and biasing the armature plate towards the electromagnetic core,
wherein, when the electromagnetic core is energized, the electromagnetic lock is maintained in a locked position, and
wherein, when the electromagnetic core is not energized, forces generated by the springs maintain the protruding position until the bolt member experiences a force tending to move the bolt member into the body.

18. The lock of claim 17, wherein, when the electromagnetic core is not energized, only forces generated by the springs maintain the protruding position of the bolt member.

19. The lock of claim 17, wherein the retractable sliding bolt is configured for a swinging-type door and the projecting portion includes oppositely arranged tapered surfaces.

20. The lock of claim 17, wherein the springs are mounted to members passing through the armature plate.

21. A method of locking a door, the method comprising:
arranging the electromagnetic lock of claim 17 on an edge of the door;
arranging a catch plate on a fixed member, the plate comprising an opening receiving therein the protruding portion of the bolt member; and
energizing the electromagnetic core in order maintained the locked position,
wherein, when the electromagnetic core is de-energized, biasing forces generated by the springs maintain engagement between the opening and the protruding portion of the retractable sliding bolt.

22. The method of claim 21, wherein, when the electromagnetic core is de-energized, biasing forces generated only by the springs maintain engagement between the opening and the protruding portion of the retractable sliding bolt, and the springs oppose and allow movement of the bolt member into the body.

23. A method of locking a door, the method comprising:
arranging the electromagnetic lock of claim 5 on an edge of the door;
arranging a catch plate on a fixed member, the plate comprising an opening receiving therein a protruding portion of the retractable sliding bolt; and
energizing an electromagnetic core in order maintained a locked position,
wherein, when the electromagnetic core is de-energized, biasing forces generated only by springs maintain engagement between the opening and the protruding portion of the retractable sliding bolt.

24. A method of locking a door, the method comprising:
arranging the electromagnetic lock of claim 12 on an edge of the door;
arranging a catch plate on a fixed member, the plate comprising an opening receiving therein a protruding portion of the retractable sliding bolt; and
energizing the electromagnetic core in order maintained the locked position,
wherein, when the electromagnetic core is de-energized, biasing forces generated only by the springs maintain engagement between the opening and the protruding portion of the retractable sliding bolt.
